(19) United States
(12) Patent Application Publication
(10) Pub. No.: US 2013/0335870 A1
(43) Pub. Date: Dec. 19, 2013

(54) ELECTROSTATIC PROTECTION CIRCUIT AND SEMICONDUCTOR DEVICE

(71) Applicant: KABUSHIKI KAISHA TOSHIBA, Tokyo (JP)

(72) Inventors: Hidefumi KUSHIBE, Kamakura-Shi (JP); Takayuki HIRAOKA, Kawasaki-Shi (JP)

(73) Assignee: KABUSHIKI KAISHA TOSHIBA, Tokyo (JP)

(21) Appl. No.: 13/776,432

(22) Filed: Feb. 25, 2013

(30) Foreign Application Priority Data
Jun. 15, 2012 (JP) 2012-135912

(51) Int. Cl. H02H 9/04

(52) U.S. Cl. CPC H02H 9/046
USPC 361/56

(57) ABSTRACT

The electrostatic protection circuit includes a first resistor connected between the power supply terminal and the grounding terminal. The electrostatic protection circuit includes a first capacitor connected in series with the first resistor. The electrostatic protection circuit includes a first inverter to which a signal based on a signal at a point of connection between the first resistor and the first capacitor is input. The electrostatic protection circuit includes a protecting MOS transistor that has a source and a drain connected between the power supply terminal and the grounding terminal and is controlled by a signal based on a first signal output to a gate thereof. The electrostatic protection circuit includes a second capacitor connected to the signal based on the first signal at a first end thereof and to the power supply terminal and/or the grounding terminal at a second end thereof.

### CROSS-REFERENCE TO RELATED APPLICATION

This application is based upon and claims the benefit of priority from the prior Japanese Patent Application No. 2012-135912, filed on Jun. 15, 2012, the entire contents of which are incorporated herein by reference.

### BACKGROUND

1. Field

Embodiments described herein relate generally to an electrostatic protection circuit and a semiconductor device.

2. Background Art

Recently, semiconductor devices have become increasingly smaller, and the fragility of circuits incorporated in semiconductor devices against an electrostatic discharge (ESD) has become a problem.

As an ESD protection for such fragile circuits, there is a technique of reducing a clamping voltage. For example, an RC-triggered MOSFET circuit is an effective protection circuit with a low clamping voltage.

### BRIEF DESCRIPTION OF THE DRAWINGS

FIG. 1 is a schematic block diagram showing a configuration of a semiconductor device 1000 according to a first embodiment;

FIG. 2 is a circuit diagram showing an example of a configuration of an electrostatic protection circuit 100 shown in FIG. 1;

FIG. 3 are diagrams showing examples of characteristics of the electrostatic protection circuit 100 according to the first embodiment and an electrostatic protection circuit according to a comparative example in a case where the impedance at the power supply terminal is high, and the rise time of the power supply voltage is short;

FIG. 4 is a circuit diagram showing an example of a configuration of an electrostatic protection circuit 200 according to a second embodiment;

FIG. 5 are diagrams showing examples of characteristics of the electrostatic protection circuit 200 according to the second embodiment and an electrostatic protection circuit according to a comparative example in a case where the impedance at the power supply terminal is high, the rise time of the power supply voltage is long, and noise is superposed on the power supply voltage;

FIG. 6 is a circuit diagram showing an example of a configuration of an electrostatic protection circuit 300 according to a third embodiment;

FIG. 7 is a circuit diagram showing an example of a configuration of an electrostatic protection circuit 400 according to the fourth embodiment; and

FIG. 8 is a circuit diagram showing an example of a configuration of an electrostatic protection circuit 500 according to the fifth embodiment.

### DETAILED DESCRIPTION

An electrostatic protection circuit according to an embodiment includes a power supply terminal to which a power supply voltage is applied. The electrostatic protection circuit includes a grounding terminal connected to a ground. The electrostatic protection circuit includes a first resistor connected between the power supply terminal and the grounding terminal. The electrostatic protection circuit includes a first capacitor connected in series with the first resistor between the power supply terminal and the grounding terminal. The electrostatic protection circuit includes a first inverter to which a signal based on a signal at a point of connection between the first resistor and the first capacitor is input. The electrostatic protection circuit includes a protecting MOS transistor that has a source and a drain connected between the power supply terminal and the grounding terminal, and a gate input to a signal based on a first signal output from the first inverter. The electrostatic protection circuit includes a second capacitor has a first end connected to the signal based on the first signal and a second end connected to the power supply terminal and/or the grounding terminal.

In the following, embodiments will be described with reference to the drawings.

### First Embodiment

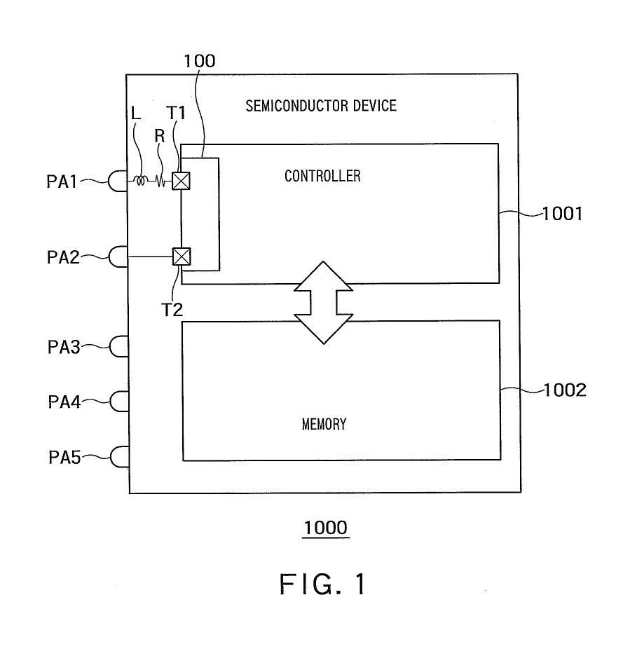

FIG. 1 is a schematic block diagram showing a configuration of a semiconductor device 1000 according to a first embodiment.

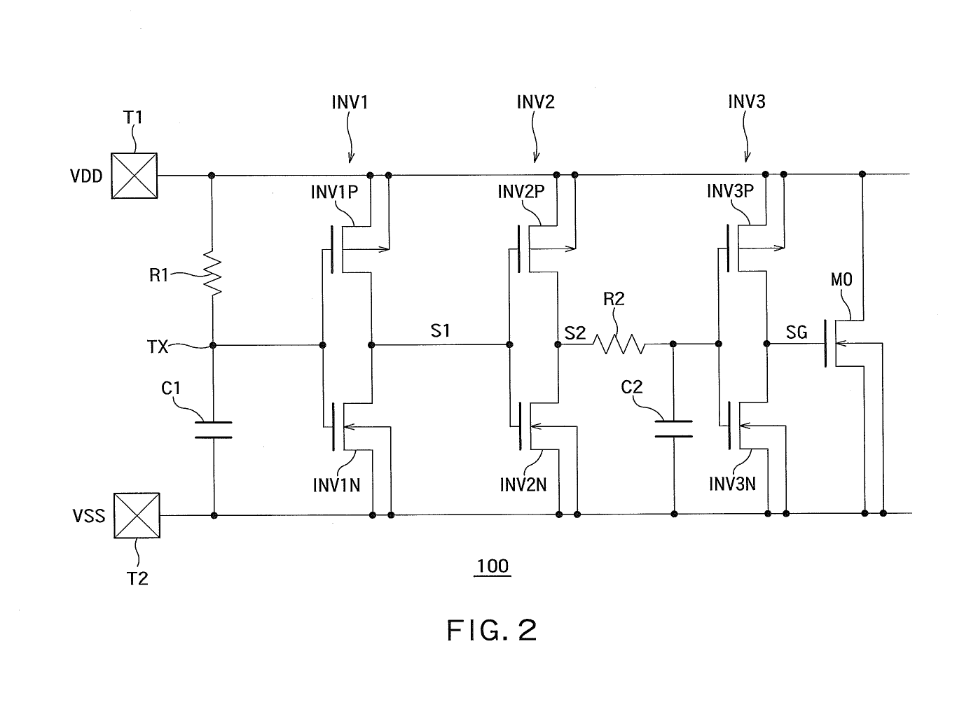

FIG. 2 is a circuit diagram showing an example of a configuration of an electrostatic protection circuit 100 shown in FIG. 1.

As shown in FIG. 1, the semiconductor device 1000 includes a memory 1002, a controller 1001 and a plurality of pads “PA1” to “PA5”.

The memory 1002 is capable of writing and reading data. The memory 1002 is a NAND type flash memory, for example.

The controller 1001 has the electrostatic protection circuit 100 and is configured to control an operation of the memory 1002. The first pad “PA1” is electrically connected to a power supply terminal “T1”, and a power supply voltage “VDD” is supplied to the first pad “PA1”.

An inductor “L” and a resistor “R” are connected between the first pad “PA1” and the power supply terminal “T1”. The inductor “L” and the resistor “R” are included in an internal circuit or a wire (both not shown), such as a bonding wire, for example.

The second pad “PA2” is electrically connected to a grounding terminal “T2” and is connected to the ground (a ground voltage is supplied to the second pad “PA2”).

The other pads “PA3” to “PA5” are connected to the controller 1001 or the memory 1002 by a wire (not shown), such as a bonding wire, and are configured to receive or output a predetermined signal.

The electrostatic protection circuit 100 of the controller 1001 has the circuit configuration shown in FIG. 2, for example.

As shown in FIG. 2, the electrostatic protection circuit 100 includes the power supply terminal “T1”, the grounding terminal “T2”, a first resistor “R1”, a second resistor “R2”, a first capacitor “C1”, a second capacitor “C2”, an inverter chain including a plurality of stages of inverters including a first inverter “INV1”, a second inverter “INV2” and a third inverter “INV3”, and a protecting MOS transistor “M0”.

In the example shown in FIG. 2, the inverter chain includes an odd number of stages.

The power supply terminal “T1” is configured to receive the power supply voltage “VDD”.

The grounding terminal “T2” is configured to be connected to the ground (or to receive the ground voltage “VSS”).

The first resistor “R1” is connected between the power supply terminal “T1” and the grounding terminal “T2”. In this embodiment, in particular, the first resistor “R1” has one end connected to the power supply terminal “T1” and the other end connected to an input of the first inverter “INV1”.

The first capacitor “C1” is connected in series with the first resistor “R1” between the power supply terminal “T1” and the grounding terminal “T2”. In this embodiment, in particular, the first capacitor “C1” has one end connected to the grounding terminal “T2” and the other end connected to the input of the first inverter “INV1”.

The input of the first inverter “INV1” is connected to a point of connection “TX” between the first resistor “R1” and the first capacitor “C1”. The first inverter “INV1” is configured to receive a signal at the point of connection “TX” and output a first signal “S1”.

As shown in FIG. 2, the first inverter “INV1” has a pMOS transistor “INV1P” and an nMOS transistor “INV1N”, for example. The pMOS transistor “INV1P” has a source connected to the power supply terminal “T1”, a drain connected to an input of the second inverter “INV2”, and a gate connected to the point of connection “TX”.

The nMOS transistor “INV1N” has a source connected to the grounding terminal “T2”, a drain connected to the drain of the pMOS transistor “INV1P”, and a gate connected to the point of connection “TX”.

The second inverter “INV2” is configured to receive a signal based on the first signal “S1” (the first signal “S1” itself in this example) and output a second signal “S2”. That is, the second signal “S2” is a signal based on the first signal “S1”.

The second inverter “INV2” is a common inverter. As shown in FIG. 2, the second inverter “INV2” has a pMOS transistor “INV2P” and an nMOS transistor “INV2N”, for example.

The pMOS transistor “INV2P” has a source connected to the power supply terminal “T1”, a drain connected to an input of the third inverter “INV3”, and a gate connected to an output of the first inverter “INV1”.

The nMOS transistor “INV2N” has a source connected to the grounding terminal “T2”, a drain connected to the drain of the pMOS transistor “INV2P”, and a gate connected to the output of the first inverter “INV1”.

The third inverter “INV3” is configured to receive a signal based on the second signal “S2” (the second signal “S2” itself in this example) and output a gate signal (a third signal) “SG”. That is, the gate signal “SG” is the signal based on the second signal “S2”. Since the second signal “S2” is the signal based on the first signal “S1” as described above, the gate signal “SG” is a signal based on the first signal “S1”.

The third inverter “INV3” is a common inverter. As shown in FIG. 2, the third inverter “INV3” has a pMOS transistor “INV3P” and an nMOS transistor “INV3N”, for example.

The pMOS transistor “INV3P” has a source connected to the power supply terminal “T1”, a drain connected to the gate of the protecting MOS transistor “M0”, and a gate connected to an output of the second inverter “INV2”.

The nMOS transistor “INV3N” has a source connected to the grounding terminal “T2”, a drain connected to the drain of the pMOS transistor “INV3P”, and a gate connected to the output of the second inverter “INV2”.

As shown in FIG. 2, the third inverter “INV3” constitutes the inverter of the last stage of the inverter chain.

The protecting MOS transistor “M0” is connected between the power supply terminal “T1.” and the grounding terminal “T2” and has a gate input to the gate signal “SG”. The protecting MOS transistor “M0” is controlled by the gate signal “SG”. According to this embodiment, in particular, the protecting MOS transistor “M0” is the nMOS transistor whose gate is connected to an output of the inverter of the last stage of the inverter chain (the third inverter “INV3”).

As shown in FIG. 2, the second capacitor “C2” has one end connected to the input of the third inverter “INV3” and the other end connected to the grounding terminal “T2”. The one end of the second capacitor “C2” is also connected to the output of the second inverter “INV2” via the second resistor “R2”.

It is enough that the one end of the second capacitor “C2” is connected any of the input of the second inverter “INV2”, the input of the third inverter “INV3” and the gate of the protecting MOS transistor “M0”. And it is enough that the other end of the second capacitor “C2” is connected to any of the power supply terminal “T1” and the grounding terminal “T2”. In this example, the one end of the second capacitor “C2” is connected to the output of the first inverter “INV1”, the output of the second inverter “INV2” or the output of the third inverter “INV3” via the second resistor “R2”. Note that there may be more than one second capacitor “C2”.

As described above, the electrostatic protection circuit 100 has the second capacitor “C2” and the second resistor “R2”, which form an RC filter.

As a result, the electrostatic protection circuit 100 can reduce noise in the second signal “S2” output from the second inverter “INV2”.

The second resistor “R2” of the RC filter may be replaced with an output resistance of an inverter of the preceding stage or a MOS resistor, for example. In this case, the second resistor “R2” is omitted.

Next, operational characteristics of the electrostatic protection circuit 100 having the configuration and functionality described above will be described.

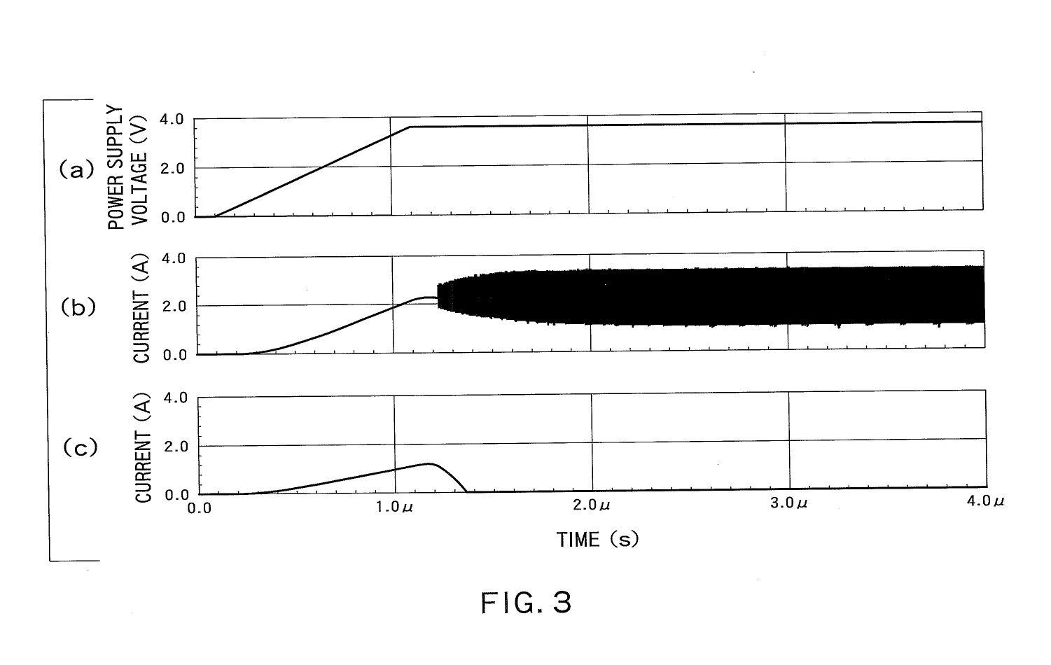

FIG. 3 are diagrams showing examples of characteristics of the electrostatic protection circuit 100 according to the first embodiment and an electrostatic protection circuit according to a comparative example in a case where the impedance at the power supply terminal is high, and the rise time of the power supply voltage is short. FIG. 3(a) shows a waveform of the power supply voltage “VDD” applied to the first pad “PA1”. FIG. 3(b) shows a waveform of the current flowing to a protecting MOS transistor in the comparative example. FIG. 3(c) shows a waveform of the current flowing to the protecting MOS transistor “M0” in the first embodiment. It is assumed that the electrostatic protection circuit according to the comparative example is configured so that the inverter chain is formed by a plurality of stages of common inverters alone.

As shown in FIGS. 3(a) and 3(b), if the rise time of the power supply voltage is short, the protecting MOS transistor of the electrostatic protection circuit according to the comparative example is turned on and oscillates.

To the contrary, as shown in FIGS. 3(a) and 3(c), the protecting MOS transistor “M0” of the electrostatic protection circuit 100 according to the first embodiment is prevented from oscillating.

As described above, with the electrostatic protection circuit 100 according to the first embodiment, the noise in the output of the second inverter “INV2” is reduced. Therefore, the protecting MOS transistor “M0” can be more appropriately turned off. In this way, the protecting MOS transistor “M0” can be prevented from oscillating.

That is, the electrostatic protection circuit according the first embodiment can reduce the influence of the state of the power supply on the electrostatic protection operation.

### Second Embodiment

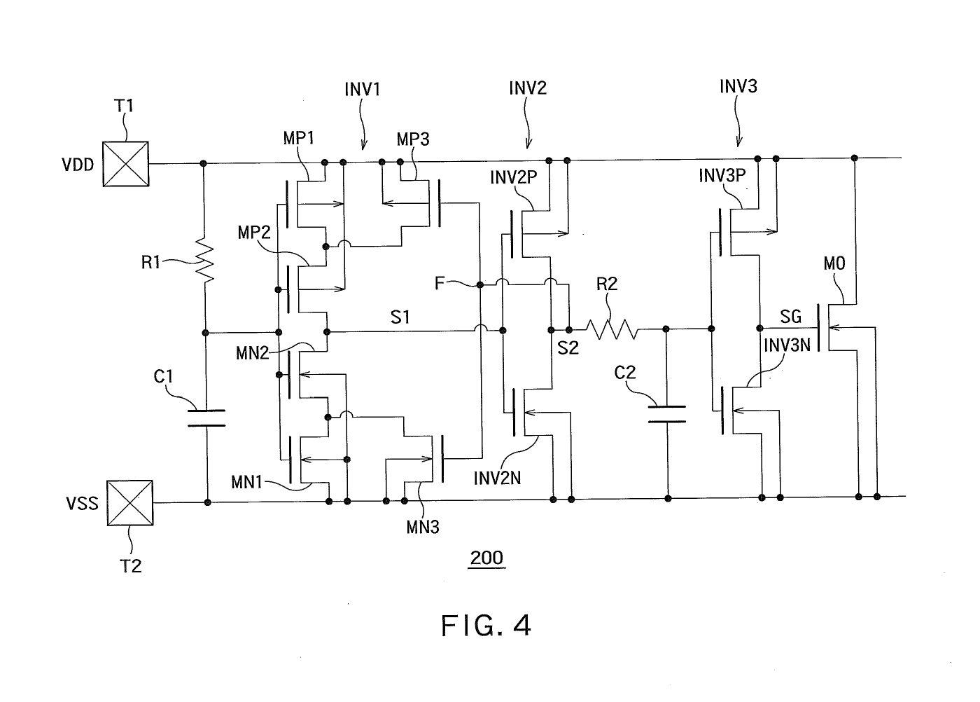

FIG. 4 is a circuit diagram showing an example of a configuration of an electrostatic protection circuit 200 according to a second embodiment. In FIG. 4, the same reference symbols as those in FIG. 2 denote the same components as those according to the first embodiment. The electrostatic protection circuit 200 according to the second embodiment is used in the semiconductor device 1000 shown in FIG. 1 as with the electrostatic protection circuit 100 according to the first embodiment.

As shown in FIG. 4, the electrostatic protection circuit 200 includes a power supply terminal “T1”, a grounding terminal “T2”, a first resistor “R1”, a first capacitor “C1”, a second capacitor “C2”, a second resistor “R2”, an inverter chain including a plurality of stages of inverters including a first inverter “INV1”, a second inverter “INV2” and a third inverter “INV3”, and a protecting MOS transistor “M0”.

According to this embodiment, the first inverter “INV1” is a Schmitt trigger inverter as shown in FIG. 4.

That is, the first inverter “INV1” has Schmitt characteristics. Therefore, even if an accidental rush current or noise in the power supply voltage causes oscillation of a signal at a point of connection “TX” between the first resistor “R1” and the first capacitor “C1”, the Schmitt characteristics of the first inverter “INV1” prevent oscillation of a first signal “S1” output from the first inverter “INV1”.

A feedback terminal “F” of the first inverter (Schmitt trigger inverter) “INV1” is connected to an output of the second inverter “INV2”.

The other end of the second capacitor “C2” is connected to the grounding terminal “T2”.

An output of the first inverter (Schmitt trigger inverter) “INV1” is connected to an input of the second inverter “INV2”.

The first inverter (Schmitt trigger inverter) “INV1” has a first pMOS transistor “MP1”, a second pMOS transistor “MP2”, a third pMOS transistor “MP3”, a first nMOS transistor “MN1”, a second nMOS transistor “MN2” and a third nMOS transistor “MN3”.

The first pMOS transistor “MP1” has a source connected to the power supply terminal “T1” and a gate connected to the point of connection “TX”.

The second pMOS transistor “MP2” has a source connected to the drain of the first pMOS transistor “MP1”, a drain connected to the input of the second inverter “INV2”, and a gate connected to the point of connection “TX”.

The third pMOS transistor “MP3” has a source connected to the power supply terminal “T1”, a drain connected to the drain of the first pMOS transistor “MP1”, and a gate connected to the output of the second inverter “INV2”.

The respective back gate of the first, second and third pMOS transistors “MP1”, “MP2” and “MP3” are connected to the power supply terminal “T1”.

The first nMOS transistor “MN1” has a source connected to the grounding terminal “T2” and a gate connected to the point of connection “TX”.

The second nMOS transistor “MN2” has a source connected to the drain of the first nMOS transistor “MN1”, a drain connected to the drain of the second pMOS transistor “MP2”, and a gate connected to the point of connection “TX”.

The third nMOS transistor “MN3” has a source connected to the grounding terminal “T2”, a drain connected to the drain of the first nMOS transistor “MN1”, and a gate connected to the gate of the third pMOS transistor “MP3”.

The respective back gate of the first, second and third nMOS transistors “MN1”, “MN2” and “MN3” are connected to the grounding terminal “T2”.

As shown in FIG. 4, the second capacitor “C2” has one end connected to an input of the third inverter “INV3” and the other end connected to the grounding terminal “T2”. The one end of the second capacitor “C2” is also connected to the output of the second inverter “INV2” via the second resistor “R2”. That is, one end of the second resistor “R2” is connected to the output of the second inverter “INV2”, and the other end of the second resistor “R2” is connected to the one end of the second capacitor “C2”.

The Schmitt trigger inverter shown in FIG. 4 is just an example, and the present invention is not limited to this Schmitt trigger inverter. The same effects as those of this embodiment can be achieved as far as the first inverter “INV1” has Schmitt characteristics. The same holds true for the embodiments described below.

Furthermore, the feedback terminal “F” of the Schmitt trigger inverter is connected to the one end of the second resistor “R2”.

The remainder of the configuration and functionality of the electrostatic protection circuit 200 is the same as that of the electrostatic protection circuit 100 according to the first embodiment.

Next, operational characteristics of the electrostatic protection circuit 200 having the configuration and functionality described above will be described.

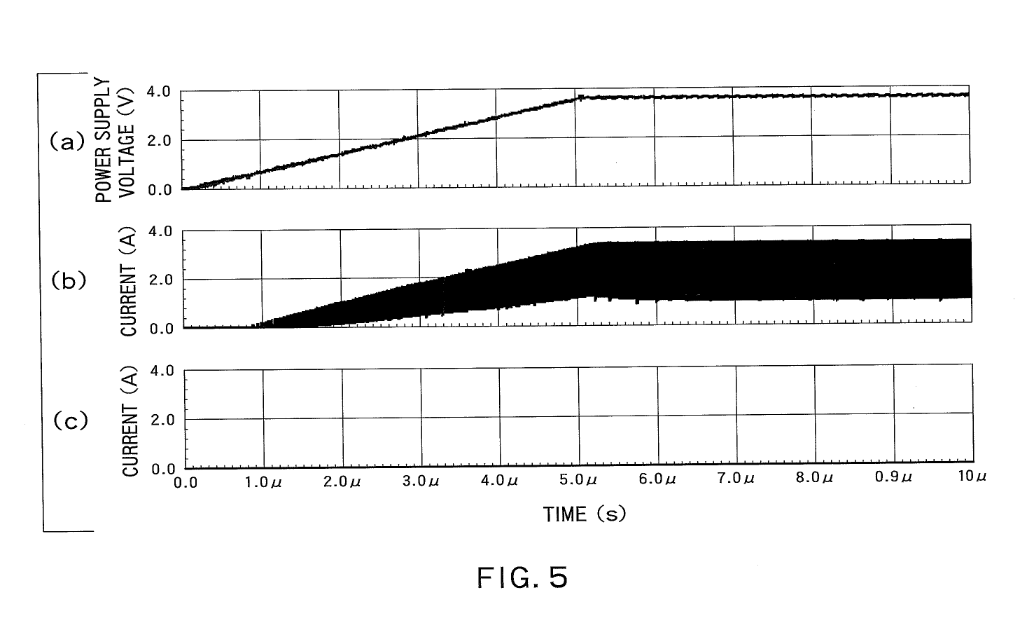

FIG. 5 are diagrams showing examples of characteristics of the electrostatic protection circuit 200 according to the second embodiment and an electrostatic protection circuit according to a comparative example in a case where the impedance at the power supply terminal is high, the rise time of the power supply voltage is long, and noise is superposed on the power supply voltage. FIG. 5(a) shows a waveform of the power supply voltage “VDD” applied to a first pad “PA1”. FIG. 5(b) shows a waveform of the current flowing to a protecting MOS transistor in the comparative example. FIG. 5(c) shows a waveform of the current flowing to the protecting MOS transistor “M0” in the second embodiment. It is assumed that the electrostatic protection circuit according to the comparative example is configured so that the inverter chain is formed by a plurality of stages of common inverters alone.

As shown in FIGS. 5(a) and 5(b), with the electrostatic protection circuit according to the comparative example, even if the power supply voltage rises gently, the protecting MOS transistor is turned on, the power supply oscillates, and a large current flows.

To the contrary, as can be seen from FIGS. 5(a) and 5(c), with the electrostatic protection circuit 200 according to the second embodiment, even if noise is superposed on the power supply voltage “VDD”, the protecting MOS transistor “M0” is not turned on as far as the rise time is long because of the Schmitt characteristics of the first inverter “INV1”. Of course, the protecting MOS transistor “M0” does not oscillate.

That is, the electrostatic protection circuit 200 according to the second embodiment can improve the stability of the power supply against an accidental rush current or noise in the power supply voltage.

The electrostatic protection circuit 200 according to the second embodiment having the configuration described above can achieve a higher stability of the power supply against an accidental rush current or noise in the power supply voltage than the electrostatic protection circuit 100 according to the first embodiment described earlier.

That is, the electrostatic protection circuit according the second embodiment can further reduce the influence of the state of the power supply on the electrostatic protection operation.

### Third Embodiment

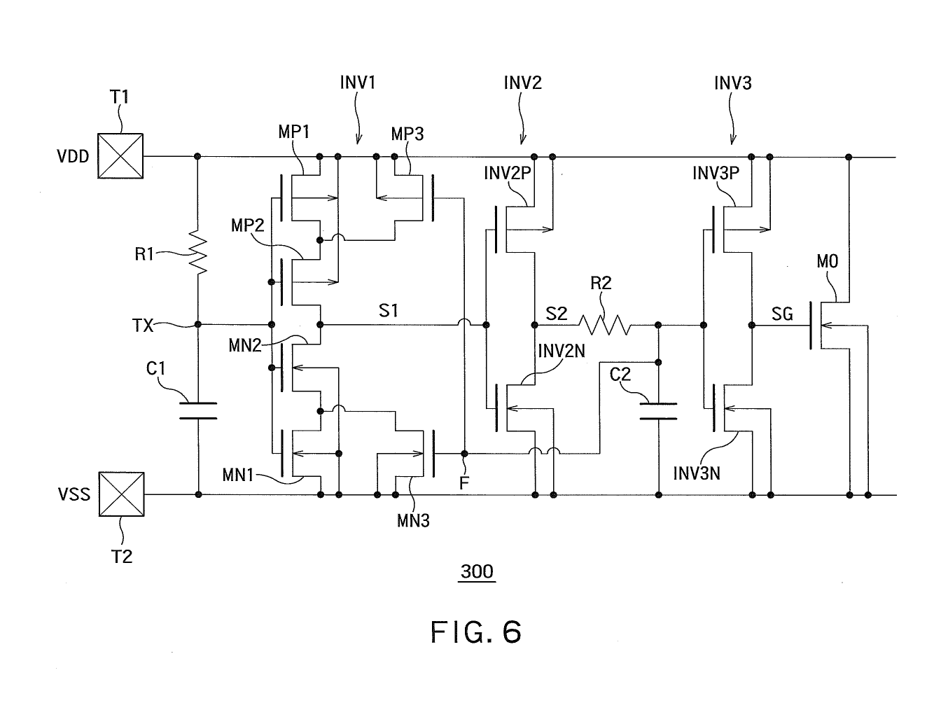

FIG. 6 is a circuit diagram showing an example of a configuration of an electrostatic protection circuit 300 according to a third embodiment. In FIG. 6, the same reference symbols as those in FIGS. 2 and 4 denote the same components as those according to the first and second embodiments. The electrostatic protection circuit 300 according to the third embodiment is used in the semiconductor device 1000 shown in FIG. 1 as with the electrostatic protection circuit 100 according to the first embodiment.

As shown in FIG. 6, the electrostatic protection circuit 300 includes a power supply terminal “T1”, a grounding terminal “T2”, a first resistor “R1”, a first capacitor “C1”, a second capacitor “C2”, a second resistor “R2”, an inverter chain including a plurality of stages of inverters including a first inverter “INV1”, a second inverter “INV2” and a third inverter “INV3”, and a protecting MOS transistor “M0”.

According to this embodiment, the first inverter “INV1” is a Schmitt trigger inverter as shown in FIG. 6. The Schmitt trigger inverter has the same configuration as the Schmitt trigger inverter in the second embodiment.

As shown in FIG. 6, the second capacitor “C2” has one end connected to an input of the third inverter “INV3” and the other end connected to the grounding terminal “T2”. The one end of the second capacitor “C2” is also connected to an output of the second inverter “INV2” via the second resistor “R2”. That is, one end of the second resistor “R2” is connected to the output of the second inverter “INV2”, and the other end of the second resistor “R2” is connected to the one end of the second capacitor “C2”.

Furthermore, a feedback terminal “F” of the Schmitt trigger inverter is connected to the other end of the second resistor “R2”.

The remainder of the configuration and functionality of the electrostatic protection circuit 300 is the same as that of the electrostatic protection circuits 100 and 200 according to the first and second embodiments.

With the electrostatic protection circuit 200 according to the second embodiment described earlier, when a rapid ESD is applied, the protecting MOS transistor is turned on and off with a high frequency oscillation waveform to let the ESD current escape. However, the electrostatic protection circuit 200 may fail to let the ESD current escape because the protecting MOS transistor is not easy to turn on again because of the Schmitt characteristics of the first inverter of the first stage.

To the contrary, with the electrostatic protection circuit 300 according to the third embodiment, since the feedback terminal “F” is connected to the other end of the second resistor “R2”, a delay time can be introduced to the Schmitt trigger inverter. As a result, the protecting MOS transistor having once been turned off with a high frequency oscillation waveform when a rapid ESD is applied can be more easily turned on again. Therefore, deterioration of the ESD resistance can be prevented.

That is, the electrostatic protection circuit according the third embodiment can further reduce the influence of the state of the power supply on the electrostatic protection operation.

### Fourth Embodiment

In a fourth embodiment, an example of a configuration in which an RC filter is connected to an output of each inverter will be described.

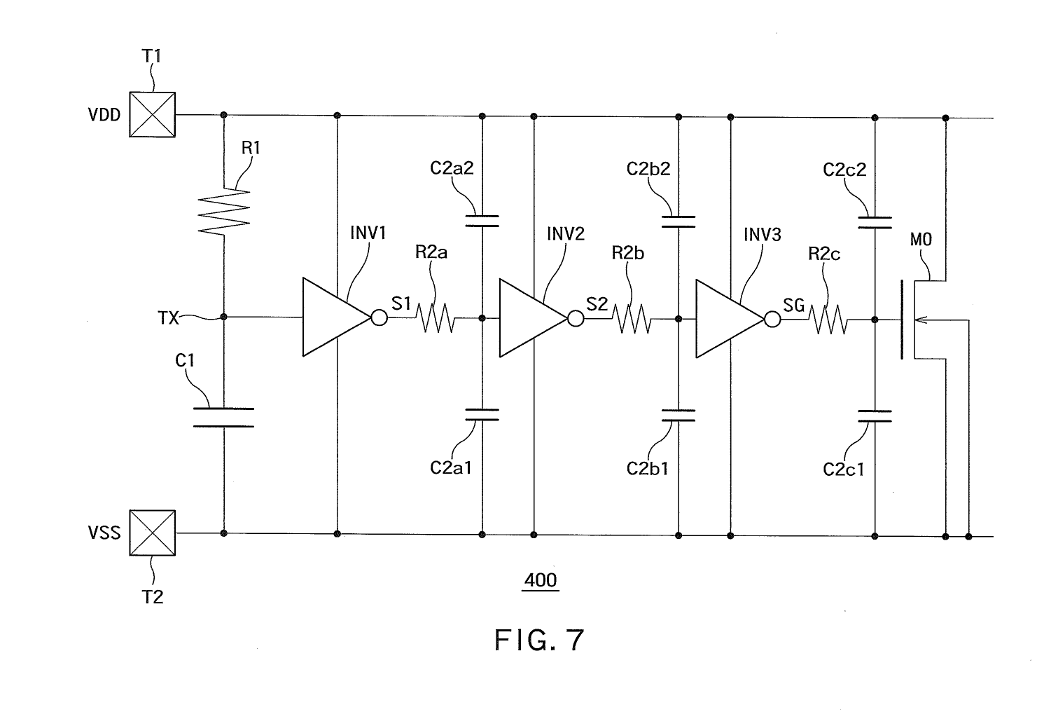

FIG. 7 is a, circuit diagram showing an example of a configuration of an electrostatic protection circuit 400 according to the fourth embodiment. In FIG. 7, the same reference symbols as those in FIG. 2 denote the same components as those according to the first embodiment. The electrostatic protection circuit 400 according to the fourth embodiment is used in the semiconductor device 1000 shown in FIG. 1 as with the electrostatic protection circuit 100 according to the first embodiment.

As shown in FIG. 7, the electrostatic protection circuit 400 includes a power supply terminal “T1”, a grounding terminal “T2”, a first resistor “R1”, a first capacitor “C1”, second capacitors “C2a1”, “C2a2”, “C2b1”, “C2b2”, “C2c1” and “C2c2”, second resistors “R2a”, “R2b” and “R2c”, an inverter chain including a plurality of stages of inverters including a first inverter “INV1”, a second inverter “INV2” and a third inverter “INV3”, and a protecting MOS transistor “M0”.

As shown in FIG. 7, the second capacitor “C2a1” has one end connected to an input of the second inverter “INV2” and the other end connected to the grounding terminal “T2”. Similarly, the second capacitor “C2a2” has one end connected to the input of the second inverter “INV2” and the other end connected to the power supply terminal “T1”.

The respective one ends of the second capacitors “C2a1” and “C2a2” are connected to an output of the first inverter “INV1” via the second resistor “R2a”.

The second capacitor “C2b1” has one end connected to an input of the third inverter “INV3” and the other end connected to the grounding terminal “T2”. Similarly, the second capacitor “C2b2” has one end connected to the input of the third inverter “INV3” and the other end connected to the power supply terminal “T1”.

The respective one ends of the second capacitors “C2b1” and “C2b2” are connected to an output of the second inverter “INV2” via the second resistor “R2b”.

The second capacitor “C2c1” has one end connected to the gate of the protecting MOS transistor “M0” and the other end connected to the grounding terminal “T2”. Similarly, the second capacitor “C2c2” has one end connected to the gate of the protecting MOS transistor “M0” and the other end connected to the power supply terminal “T1”.

The respective one ends of the second capacitors “C2c1” and “C2c2” are connected to an output of the third inverter “INV3” via the second resistor “R2c”.

As described above, the RC filter can be connected to the output of any inverter, and the second capacitor can be connected to the power supply terminal “T1” rather than the grounding terminal “T2”.

The remainder of the configuration and functionality of the electrostatic protection circuit 400 is the same as that of the electrostatic protection circuit 100 according to the first embodiment.

The electrostatic protection circuit 400 having the configuration described above can prevent oscillation of the protecting MOS transistor because noise is reduced.

That is, the electrostatic protection circuit according the fourth embodiment can reduce the influence of the state of the power supply on the electrostatic protection operation.

### Fifth Embodiment

In a fifth embodiment, there will be described an example of the configuration of the electrostatic protection circuit according to the fourth embodiment described earlier in which the first inverter “INV1” is a Schmitt trigger inverter.

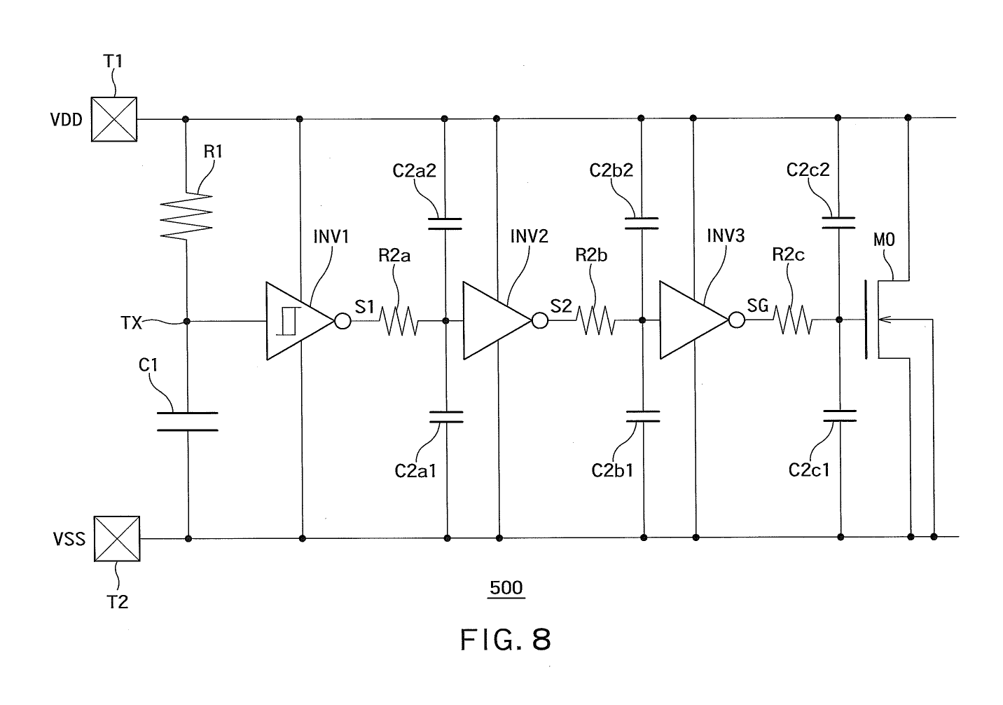

FIG. 8 is a circuit diagram showing an example of a configuration of an electrostatic protection circuit 500 according to the fifth embodiment. In FIG. 8, the same reference symbols as those in FIG. 7 denote the same components as those according to the fourth embodiment. The electrostatic protection circuit 500 according to the fifth embodiment is used in the semiconductor device 1000 shown in FIG. 1 as with the electrostatic protection circuit 100 according to the first embodiment.

According to this embodiment, the first inverter “INV1” is a Schmitt trigger inverter as shown in FIG. 8.

That is, the first inverter “INV1” has Schmitt characteristics. Therefore, even if an accidental rush current or noise in the power supply voltage causes oscillation of the signal at a point of connection “TX”, the Schmitt characteristics of the first inverter “INV1” prevent oscillation of a first signal “S1” output from the first inverter “INV1”.

The remainder of the configuration and functionality of the electrostatic protection circuit 500 is the same as that of the electrostatic protection circuit 400 according to the fourth embodiment.

The electrostatic protection circuit 500 having the configuration described above can prevent oscillation of the protecting MOS transistor because noise is reduced and can prevent the protecting MOS transistor from being turned on by power supply noise that occurs when the power supply voltage rises.

That is, the electrostatic protection circuit according the fifth embodiment can further reduce the influence of the state of the power supply on the electrostatic protection operation.

According to the embodiments described above, the electrostatic protection circuits include an inverter chain including an odd number, equal to or greater than one, of stages of inverters (including the first to third inverters “INV1” to “INV3”, for example), the first resistor “R1” has one end connected to the power supply terminal “T1” and the other end connected to the input of the first inverter “INV1”, the first capacitor “C1” has one end connected to the grounding terminal “T2” and the other end connected to the input of the first inverter “INV1”, and the protecting MOS transistor “M0” is an nMOS transistor whose gate is connected to the output of the inverter of the last stage of the inverter chain.

However, the electrostatic protection circuits may include an inverter chain including an even number of stages of inverters (including the first to third inverters “INV1” to “INV3”, for example), the first resistor “R1” may have one end connected to the power supply terminal “T1” and the other end connected to the input of the first inverter “INV1”, the first capacitor “C1” may have one end connected to the grounding terminal “T2” and the other end connected to the input of the first inverter “INV1”, and the protecting MOS transistor “M0” may be a pMOS transistor whose gate is connected to the output of the inverter of the last stage of the inverter chain.

Alternatively, the electrostatic protection circuits may include an inverter chain including an even number of stages of inverters (including the first to third inverters “INV1” to “INV3”, for example), the first resistor “R1” may have one end connected to the grounding terminal “T2” and the other end connected to the input of the first inverter “INV1”, the first capacitor “C1” may have one end connected to the power supply terminal “T1” and the other end connected to the input of the first inverter “INV1”, and the protecting MOS transistor “M0” may be an nMOS transistor whose gate is connected to the output of the inverter of the last stage of the inverter chain.

Alternatively, the electrostatic protection circuits may include an inverter chain including an odd number, equal to or greater than one, of stages of inverters (including the first to third inverters “INV1” to “INV3”, for example), the first resistor “R1” may have one end connected to the grounding terminal “T2” and the other end connected to the input of the first inverter “INV1”, the first capacitor “C1” may have one end connected to the power supply terminal “T1” and the other end connected to the input of the first inverter “INV1”, and the protecting MOS transistor “M0” may be a pMOS transistor whose gate is connected to the output of the inverter of the last stage (the third inverter “INV3”) of the inverter chain.

The arrangements of the second capacitors in the fourth and fifth embodiments described above are just examples, and only part of the second capacitors described above may be provided, and the second resistors may be omitted.

Although the first to third inverters have been described in the above embodiments, the present invention is not limited to the inverters. That is, the inverters may be replaced with, or used in combination with, buffers, which do not perform inversion. In the case where the inverters in the first embodiment are replaced with buffers, which do not perform inversion (that is, the first to third inverters are all replaced with buffers, which do not perform inversion), the same effects as those of the first embodiment can be achieved by interchanging the first resistor “R1.” and the first capacitor “C1” in the circuit shown in FIG. 2 or replacing the protecting MOS transistor “M0” in the circuit shown in FIG. 2 with a pMOS transistor.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electrostatic protection circuit, comprising:
a power supply terminal to which a power supply voltage is applied;
a grounding terminal connected to a ground;
a first resistor connected between the power supply terminal and the grounding terminal;
a first capacitor connected in series with the first resistor between the power supply terminal and the grounding terminal;
a first inverter to which a signal based on a signal at a point of connection between the first resistor and the first capacitor is input;
a protecting MOS transistor that has a source and a drain connected between the power supply terminal and the grounding terminal, and a gate input to a signal based on a first signal output from the first inverter; and
a second capacitor has a first end connected to the signal based on the first signal and a second end connected to the power supply terminal and/or the grounding terminal.

2. The electrostatic protection circuit according to claim 1, further comprising a second resistor,
wherein the first end of the second capacitor is connected to the output of the second inverter via the second resistor.

3. The electrostatic protection circuit according to claim 1, wherein the first inverter is a Schmitt trigger inverter.

4. The electrostatic protection circuit according to claim 3, wherein an output of the Schmitt trigger inverter is connected to an input of a second inverter, and
a feedback terminal of the Schmitt trigger inverter is connected to an output of the second inverter.

5. The electrostatic protection circuit according to claim 4, further comprising a second resistor,
wherein
a first end of the second resistor is connected to the output of the second inverter,
a second end of the second resistor is connected to the first end of the second capacitor, and
the feedback terminal is connected to the first end of the second resistor.

6. The electrostatic protection circuit according to claim 4, further comprising a second resistor,
wherein
a first end of the second resistor is connected to the output of the second inverter,
a second end of the second resistor is connected to the first end of the second capacitor, and
the feedback terminal is connected to the second end of the second resistor.

7. The electrostatic protection circuit according to claim 1, wherein the electrostatic protection circuit includes an inverter chain including an odd number of stages of inverters including the first inverter,
the first resistor has a first end connected to the power supply terminal and a second end connected to an input of the first inverter,
the first capacitor has a first end connected to the grounding terminal and a second end connected to the input of the first inverter, and
the protecting MOS transistor is an nMOS transistor whose gate is connected to an output of an inverter of a last stage of the inverter chain.

8. The electrostatic protection circuit according to claim 1, wherein the electrostatic protection circuit includes an inverter chain including an even number of stages of inverters including the first inverter,
the first resistor has a first end connected to the power supply terminal and a second end connected to an input of the first inverter,
the first capacitor has a first end connected to the grounding terminal and a second end connected to the input of the first inverter, and
the protecting MOS transistor is an pMOS transistor whose gate is connected to an output of an inverter of a last stage of the inverter chain.

9. The electrostatic protection circuit according to claim 1, wherein the electrostatic protection circuit includes an inverter chain including an odd number of stages of inverters including the first inverter,
the first resistor has a first end connected to the grounding terminal and a second end connected to an input of the first inverter,
the first capacitor has a first end connected to the power supply terminal and a second end connected to the input of the first inverter at a second end thereof, and
the protecting MOS transistor is an pMOS transistor whose gate is connected to an output of an inverter of a last stage of the inverter chain.

10. The electrostatic protection circuit according to claim 1, wherein the electrostatic protection circuit includes an inverter chain including an even number of stages of inverters including the first inverter,
the first resistor has a first end connected to the grounding terminal at a first end thereof and a second end connected to an input of the first inverter,
the first capacitor has a first end connected to the power supply terminal and a second end connected to the input of the first inverter, and
the protecting MOS transistor is an nMOS transistor whose gate is connected to an output of an inverter of a last stage of the inverter chain.

11. The electrostatic protection circuit according to claim 3, wherein an output of the Schmitt trigger inverter is connected to the input of the second inverter,
the Schmitt trigger inverter comprising:
a first pMOS transistor that has a source connected to the power supply terminal and a gate connected to a point of connection between the first resistor and the first capacitor;
a second pMOS transistor that has a source connected to a drain of the first pMOS transistor, a drain connected to the input of the second inverter, and a gate connected to the point of connection;
a third pMOS transistor that has a source connected to the power supply terminal, a drain connected to the drain of the first pMOS transistor, and a gate connected to the output of the second inverter;
a first nMOS transistor that has a source connected to the grounding terminal and a gate connected to the point of connection;
a second nMOS transistor that has a source connected to a drain of the first nMOS transistor, a drain connected to the drain of the second pMOS transistor, and a gate connected to the point of connection; and
a third nMOS transistor that has a source connected to the grounding terminal, a drain connected to the drain of the first nMOS transistor, and a gate connected to the gate of the third pMOS transistor.

12. A semiconductor device, comprising:
a memory capable of writing and reading data; and
a controller that has an electrostatic protection circuit and controls an operation of the memory,
wherein the electrostatic protection circuit, comprising:
a power supply terminal to which a power supply voltage is applied;
a grounding terminal connected to a ground;
a first resistor connected between the power supply terminal and the grounding terminal;
a first capacitor connected in series with the first resistor between the power supply terminal and the grounding terminal;
a first inverter to which a signal based on a signal at a point of connection between the first resistor and the first capacitor is input;
a protecting MOS transistor that has a source and a drain connected between the power supply terminal and the grounding terminal, and a gate input to a signal based on a first signal output from the first inverter; and
a second capacitor has a first end connected to the signal based on the first signal and a second end connected to the power supply terminal and/or the grounding terminal.

13. The semiconductor device according to claim 12, further comprising:
a first pad that is electrically connected to the power supply terminal, and supplied a power supply voltage; and
wherein a inductor and a resistor are connected between the first pad and the power supply terminal.

14. The semiconductor device according to claim 12, wherein the electrostatic protection circuit further comprises a second resistor,
wherein the first end of the second capacitor is connected to an output of a second inverter via the second resistor.

15. The semiconductor device according to claim 12, wherein the first inverter is a Schmitt trigger inverter.

16. The semiconductor device according to claim 15, wherein an output of the Schmitt trigger inverter is connected to an input of a second inverter, and
a feedback terminal of the Schmitt trigger inverter is connected to an output of the second inverter.

17. The semiconductor device according to claim 12, wherein the electrostatic protection circuit includes an inverter chain including an odd number of stages of inverters including the first inverter,
the first resistor has a first end connected to the power supply terminal and a second end connected to an input of the first inverter,
the first capacitor has a first end connected to the grounding terminal and a second end connected to the input of the first inverter, and
the protecting MOS transistor is an nMOS transistor whose gate is connected to an output of an inverter of a last stage of the inverter chain.

18. The semiconductor device according to claim 12, wherein the electrostatic protection circuit includes an inverter chain including an even number of stages of inverters including the first inverter,
the first resistor has a first end connected to the power supply terminal and a second end connected to an input of the first inverter,
the first capacitor has a first end connected to the grounding terminal and a second end connected to the input of the first inverter, and
the protecting MOS transistor is an pMOS transistor whose gate is connected to an output of an inverter of a last stage of the inverter chain.

19. The semiconductor device according to claim 12, wherein the electrostatic protection circuit includes an inverter chain including an odd number of stages of inverters including the first inverter,
the first resistor has a first end connected to the grounding terminal and a second end connected to an input of the first inverter,
the first capacitor has a first end connected to the power supply terminal and a second end connected to the input of the first inverter, and
the protecting MOS transistor is an pMOS transistor whose gate is connected to an output of an inverter of a last stage of the inverter chain.

20. The semiconductor device according to claim 16, wherein an output of the Schmitt trigger inverter is connected to the input of the second inverter,
the Schmitt trigger inverter comprising:
a first pMOS transistor that has a source connected to the power supply terminal and a gate connected to a point of connection between the first resistor and the first capacitor;
a second pMOS transistor that has a source connected to a drain of the first pMOS transistor, a drain connected to the input of the second inverter, and a gate connected to the point of connection;
a third pMOS transistor that has a source connected to the power supply terminal, a drain connected to the drain of the first pMOS transistor, and a gate connected to the output of the second inverter;
a first nMOS transistor that has a source connected to the grounding terminal and a gate connected to the point of connection;
a second nMOS transistor that has a source connected to a drain of the first nMOS transistor, a drain connected to the drain of the second pMOS transistor, and a gate connected to the point of connection; and
a third nMOS transistor that has a source connected to the grounding terminal, a drain connected to the drain of the first nMOS transistor, and a gate connected to the gate of the third pMOS transistor.
